(19) United States
(12) Patent Application Publication
(10) Pub. No.: US 2009/0021201 A1
(43) Pub. Date: Jan. 22, 2009

(54) CONSTANT-CURRENT AND CONSTANT-VOLTAGE DRIVING CIRCUIT OF DCBL FAN MOTOR WITH LOW ACOUSTIC NOISE AND CONTROLLABLE SPEED

(75) Inventors: Yi-Pin Lin, Hsinchu (TW); Sheng-Yi Yang, Hualien County (TW)

Correspondence Address: PAI PATENT & TRADEMARK LAW FIRM, 1001 FOURTH AVENUE, SUITE 3200, SEATTLE, WA, 98154, US

(73) Assignee: AMPSON TECHNOLOGY, INC., Hsinchu (TW)

(21) Appl. No.: 11/779,879

(22) Filed: Jul. 18, 2007

(51) Int. Cl. H02P 7/00

(52) U.S. Cl. 318/432

(57) ABSTRACT

A constant-current and constant-voltage driving circuit of a DC motor is used for driving a first magnetic coil and a second magnetic coil included in the DC motor. The driving circuit includes an integrated circuit chip, a first switch and a second switch. The integrated circuit chip generates currents to drive the first switch and the second switch by using the constant-current driving method. The first switch and the second switch amplify the generated currents by using the constant-voltage driving method, to drive the first magnetic coil and the second magnetic coil, respectively. Furthermore, the driving circuit can also include a control circuit to control the first magnetic coil and the second magnetic coil with pulse width modulation signals, so as to obtain the required rotation frequency of the DC motor.

### BACKGROUND

1. Field of Invention

The present invention relates to a driving circuit of a direct-current motor. More particularly, the present invention relates to a driving circuit, using a constant-current and constant-voltage method, for driving a direct-current brushless (DCBL) fan motor.

2. Description of Related Art

Traditionally, a DC brushless fan is used to dissipate heat in electronic devices. When the heat is accumulated within the devices and cannot be dissipated, components of the devices cannot function and operate well, and the whole system may even fail or be permanently damaged. Therefore, a DC fan incorporating a DC brushless motor can act as a heat-dissipating device to enable system components to operate normally in an environment with a suitable temperature.

A conventional method for driving a DC motor is a constant-voltage driving method. FIG. 1A shows a driving circuit using the constant-voltage driving method. The driving circuit 100 includes two transistors M1 and M2, and the transistors M1 and M2 both are NPN bipolar junction transistors (BJT), and their collector-to-emitter voltages are V_{ce1} and V_{ce2}, respectively, which are the voltages of the two output nodes DO and DOB in FIG. 1A. The voltages of the two output nodes DO and DOB are used to drive two magnetic coils L1 and L2, to generate the magnetic field, of the DC motor, in which the impedances of the two magnetic coils L1 and L2 are Z1 and Z2, respectively. Furthermore, the supply voltage and the total supply current are VCC and ICC, respectively, and the currents flowing through the two magnetic coils L1 and L2 are I1 and I2, respectively.

When the constant-voltage driving method is used, two control voltage signals V1 and V2 control two transistors M1 and M2 that are turned on non-simultaneously. Each of the transistors is operated in the cut-off region when turned off, so that the current flowing through the transistor is very small and close to zero. Therefore, the voltage of the output node is approximately equal to VCC. When each of the transistors is turned on, the current flowing through the transistor increases gradually and the transistor is operated in the saturation region, in which the collector-to-emitter saturation voltages of the transistors M1 and M2 are V_{ce1, sat} and V_{ce2, sat}, respectively, both values of which are nearly constant. At the moment,

VCC=V_{ce1, sat}+I1*Z1=V_{ce2, cutoff}+I2*Z2

or VCC=V_{ce2, sat}+I2*Z2=V_{ce1, cutoff}+I1*Z1

, in which Z1 and Z2 are determined by the coil resistors of the two magnetic coils L1 and L2 and the rotation frequency of the motor.

However, the constant-voltage driving method is more suitable for the large current condition. If the constant-voltage driving method is still used for the motor that has a small driving current, for the magnetic coil L1 (same as L2), the V_{ce1} is constant and the coil resistor has a relatively large value, the supply voltage VCC varied over a small range can accordingly cause the small current I1 to vary proportionally over a large range, so that the rotation speed of the motor changes and is unstable. Therefore, this type of driving method is not suitable for the low-rotation-speed and small-current motor.

Moreover, for the constant-voltage driving method, when the transistor M1 (or transistor M2) is switched to turn on and turn off, a counter-electromotive force is induced on the magnetic coil L1 (or magnetic coil L2) because of the change of the magnetic field, and the counter-electromotive force makes the magnetic coil and the whole motor generate considerable noise. FIG. 1B shows the measured waveforms of the DC supply voltage and the output voltages of the output nodes DO and DOB. Referring to FIG. 1B, when the transistors M1 and M2 are switched, the output voltages of the output nodes DO and DOB have instantaneous counter-electromotive forces, and the measured supply voltage VCC has the power noise as well. FIG. 1C shows the measured waveforms of the output voltages of the output nodes DO and DOB and the corresponding frequency spectrum. Referring to FIG. 1C, because of the power noise and the counter-electromotive forces of the output nodes DO and DOB, many odd-fold frequencies and even-fold frequencies exist in the frequency spectrum except the base band (70 Hz). Besides, the odd-fold frequencies and even-fold frequencies converge slowly to cause the main noise.

A prior method for solving the foregoing problems is to use a constant-current driving method, which is suitable for slow-rotation and low-current motors. FIG. 2 shows a driving circuit using the constant-current driving method. The driving circuit 200 includes two transistors M3 and M4 which respectively has a terminal connected to a first reference voltage VSS, in which the two transistors M3 and M4 are the NPN bipolar junction transistors (BJT), and their collector-to-emitter voltages are V_{ce3} and V_{ce4}, respectively, which are the voltages of the two output nodes DO and DOB in FIG. 2. The voltages of the two output nodes DO and DOB are used to drive two magnetic coils L3 and L4 that generate the magnetic field of the DC motor, in which the impedances of the two magnetic coils L3 and L4 are Z3 and Z4 respectively. Furthermore, the supply voltage is VCC, and the currents flowing through the two magnetic coils L3 and L4 are I3 and I4, respectively.

Two control voltage signals V3 and V4 control two transistors M3 and M4 that are turned on non-simultaneously. When the transistor M3 is turned on, the transistor M3 is operated in the active region according to the control voltage signal V3. Therefore, the current I3 flowing through the magnetic coil L3 is approximately constant. Similarly, when the transistor M4 is turned on, the transistor M4 is operated in the active region according to the control voltage signal V4. Therefore, the current I4 flowing through the magnetic coil L4 is approximately constant as well. At the moment,

VCC=V_{ce3, active}+I3*Z3=V_{ce4, cutoff}+I4*Z4, and I4=0

or VCC=V_{ce4, active}+I4*Z4=V_{ce3, cutoff}+I3*Z3, and I3=0

,in which I3 and I4 are constant and determined by the specifications, and Z3 and Z4 are determined by the coil resistors of the two magnetic coils L3 and L4 and the rotation frequency of the motor. Therefore, the transistors M3 and M4 are respectively treated like a constant current source; that is, the current source is generated when the transistor is turned on, so as to provide the constant current. Although the constant-current driving method can be used to solve some problems caused by using the constant-voltage driving method, however, the operating current cannot be increased when considering the heat dissipation for the IC. Therefore, it is not suitable for the fast-rotation motors.

For the foregoing reasons, there is a need to provide a driving circuit capable of reducing the noise generated by the motor, and suitable for the fast-rotation and large-current motor as well.

### SUMMARY

In accordance with one embodiment of the present invention, a constant-current and constant-voltage driving circuit of a direct-current motor is provided. The direct-current motor includes a first magnetic coil and a second magnetic coil. The first magnetic coil has a first terminal and a second terminal. The second magnetic coil has a third terminal and a fourth terminal. The second terminal and the fourth terminal are electrically coupled to a first reference voltage. The constant-current and constant-voltage driving circuit includes an integrated circuit chip, a first switch and a second switch. The integrated circuit chip has a first chip output terminal and a second chip output terminal. The first switch has a first control terminal, a fifth terminal and a sixth terminal. The first control terminal is electrically coupled to the first chip output terminal of the integrated circuit chip, the fifth terminal is electrically coupled to a second reference voltage, and the sixth terminal is electrically coupled to the first terminal of the first magnetic coil. The second switch has a second control terminal, a seventh terminal and an eighth terminal. The second control terminal is electrically coupled to the second chip output terminal of the integrated circuit chip, the seventh terminal is electrically coupled to the second reference voltage, and the eighth terminal is electrically coupled to the third terminal of the second magnetic coil.

The first switch and the second switch are non-simultaneously turned on according to a first current and a second current respectively, which flow through the first chip output terminal and the second chip output terminal, so as to drive the first magnetic coil and the second magnetic coil respectively. Both the first current and the second current are substantially constant. The first magnetic coil and the second magnetic coil are non-simultaneously driven according to respective constant voltages generated by the first switch and the second switch.

For the foregoing embodiment of the present invention, the driving circuit of the DC motor has the advantages of using the constant-current and constant-voltage driving method, and can be not only used to reduce the noise caused by the motor, but also suitable for a fast-rotation and large-current motor.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the preferred embodiment, with reference made to the accompanying drawings as follows:

FIG. 1A shows a driving circuit using the constant-voltage driving method;

FIG. 1B shows the measured waveforms of the DC supply voltage and the output voltages of the output nodes DO and DOB;

FIG. 1C shows the measured waveforms of the output voltages of the output nodes DO and DOB and the corresponding frequency spectrum;

FIG. 2 shows a driving circuit using the constant-current driving method;

FIG. 3 shows the driving circuit of the DC motor according to a first embodiment of the present invention;

FIG. 4 shows the driving circuit of the DC motor according to a second embodiment of the present invention;

FIG. 5 is a circuit block diagram of the internal part of the IC chip shown in FIG. 3;

FIG. 6 shows the internal driving circuit of the IC chip shown in FIG. 3 and the external circuit connected thereto;

FIG. 7 shows the driving circuit of the DC motor according to a third embodiment of the present invention;

FIG. 8 shows the driving circuit, including the circuit for generating the frequency detection signal, of the DC motor according to a fourth embodiment of the present invention;

FIG. 9 shows the measured waveforms of the voltages of the output terminals DO′ and DOB′ and the frequency detection signal;

FIG. 10 shows the driving circuit, including the circuit for generating the frequency detection signal, of the DC motor according to a fifth embodiment of the present invention;

FIG. 11 shows the driving circuit, including the PWM control circuit, of the DC motor according to a sixth embodiment of the present invention;

FIG. 12 shows the driving circuit, including the PWM control circuit, of the DC motor according to a seventh embodiment of the present invention;

FIG. 13 shows the driving circuit, including the PWM control circuit and the circuit for generating the frequency detection signal, of the DC motor according to an eighth embodiment of the present invention;

FIG. 14 shows the internal driving circuit of the IC chip and the external circuit connected thereto according to another embodiment of the present invention;

FIG. 15 shows the internal driving circuit of the IC chip and the external circuit connected thereto according to yet another embodiment of the present invention;

FIG. 16 shows the partial waveforms of the currents, which are of the collectors of the transistors Q_{DO} and Q_{DOB}, relative to the time;

FIG. 17 shows the measured waveforms of the output voltages of the output terminals DO′ and DOB′ and the DC power supply shown in FIG. 6 when the high DC voltage is 12V;

FIG. 18 shows the measured waveforms and the corresponding spectrum of the output voltages of the output terminals DO′ and DOB′ shown in FIG. 6 when the high DC voltage is 12V;

FIG. 19 shows the measured waveforms of the output voltages of the output terminals DO′ and DOB′ and the DC power supply shown in FIG. 6 when the high DC voltage is 24V; and

FIG. 20 shows the measured waveforms and the corresponding spectrum of the output voltages of the output terminals DO′ and DOB′ shown in FIG. 6 when the high DC voltage is 24V.

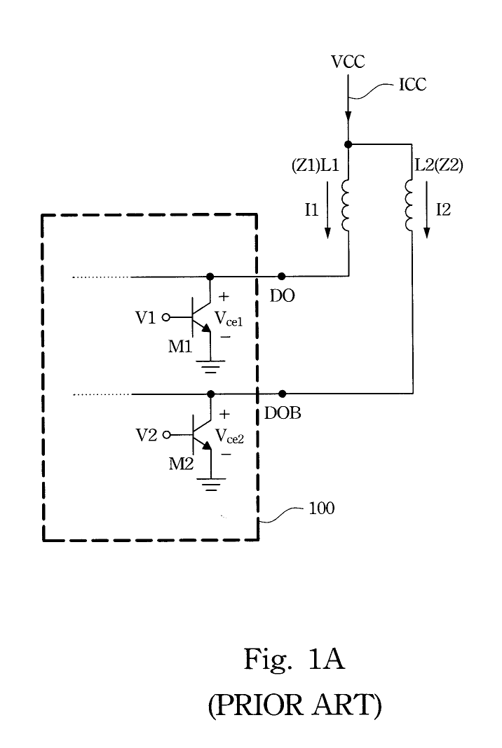

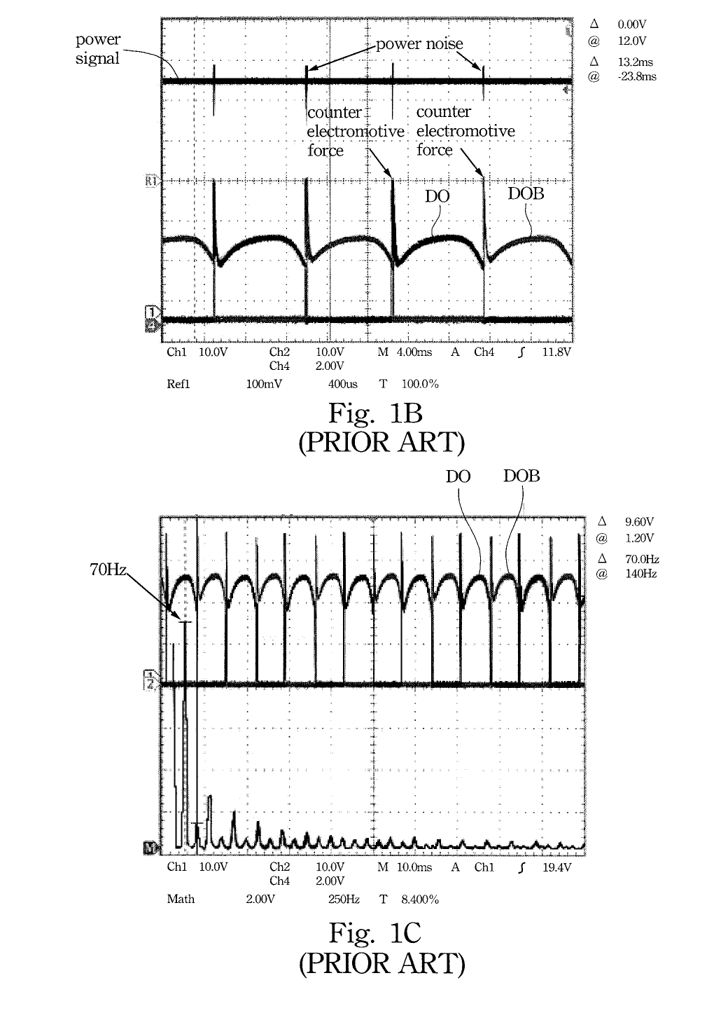

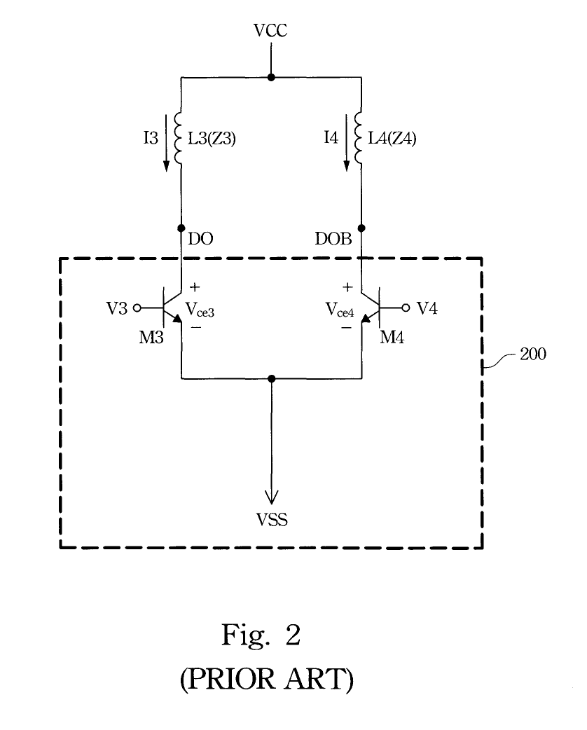

### DESCRIPTION OF THE PREFERRED EMBODIMENTS

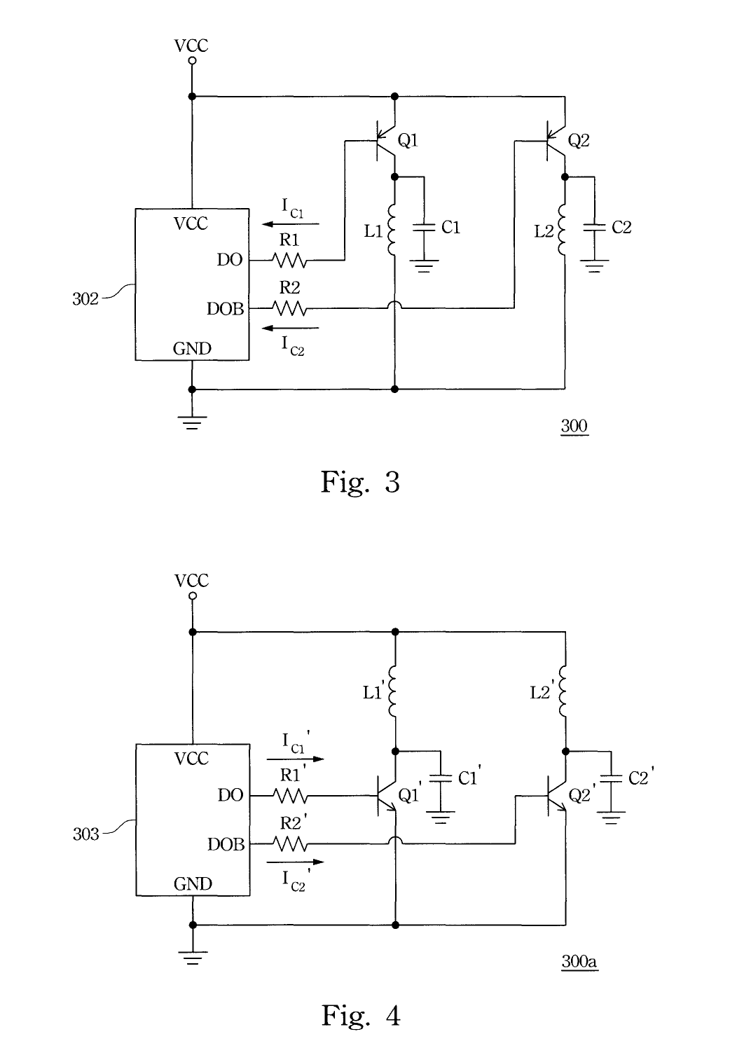

FIG. 3 shows the driving circuit of the DC motor according to a first embodiment of the present invention. The DC motor includes two magnetic coils L1 and L2. The magnetic coil L1 has one terminal electrically coupled to a first reference voltage, and the magnetic coil L2 has one terminal electrically coupled to the first reference voltage as well. The first reference voltage is a ground terminal GND in the present embodiment. The driving circuit 300 includes an integrated circuit (IC) chip 302 and two switches Q1 and Q2. In the present embodiment both switches Q1 and Q2 are PNP bipolar junction transistors (BJT). The IC chip 302 is made in a single-in-line package (SIP) is form with four pins. The four pins are the terminals coupled to the second reference voltage VCC, the chip output terminals DO and DOB, and the terminal coupled to the ground terminal, respectively. The second reference voltage VCC is a high DC voltage in the present embodiment. The control terminal, i.e. the base, of the transistor Q1 is electrically coupled to the chip output terminal DO of the IC chip 302. The emitter of the transistor Q1 is electrically coupled to the high DC voltage VCC. The collector of the transistor Q1 is electrically coupled to the other terminal of the magnetic coil L1. The control terminal, i.e. the base, of the transistor Q2 is electrically coupled to the chip output terminal DOB of the IC chip 302. The emitter of the transistor Q2 is electrically coupled to the high DC voltage VCC. The collector of the transistor Q2 is electrically coupled to the other terminal of the magnetic coil L2.

When the IC chip 302 works, the corresponding currents I_{C1} and I_{C2} are generated non-simultaneously at the chip output terminals DO and DOB. Besides, the transistors Q1 and Q2 are non-simultaneously turned on according to the magnetic field, the controlling state, and the currents I_{C1} and I_{C2}, which flow through the chip output terminals DO and DOB respectively, so as to drive the magnetic coils L1 and L2 respectively. The current I_{C1} and I_{C2} are substantially constant and flow into the chip output terminals DO and DOB, respectively. The two magnetic coils L1 and L2 are driven non-simultaneously according to respective constant voltages generated by the transistors Q1 and Q2.

Furthermore, the driving circuit 300 can further include two resistors R1 and R2 and two capacitors C1 and C2. The resistor R1 is electrically coupled between the control terminal of the transistor Q1 and the chip output terminal DO of the IC chip 302. The resistor R2 is electrically coupled between the control terminal of the transistor Q2 and the chip output terminal DOB of the IC chip 302. The two resistors R1 and R2 reduce the voltages of the chip output terminals DO and DOB, respectively; to reduce the operating power of the IC chip 302 and further decrease the operating temperature of the IC chip 302. In addition, the two resistors R1 and R2 have to make the transistors Q1 and Q2 operate in the saturation region and make sure that the transistors Q1 and Q2 do not over-heat when current flows through them. The two capacitors C1 and C2 are electrically coupled to one terminal of the magnetic coil L1 and one terminal of the magnetic coil L2, respectively, and the collector of the transistor Q1 and the collector of the transistor Q2, respectively, to further reduce the surge caused by the counter-electromotive force.

FIG. 4 shows the driving circuit of the DC motor according to a second embodiment of the present invention. The DC motor includes two magnetic coils L1′ and L2′. The magnetic coil L1′ has one terminal electrically coupled to the high DC voltage VCC, and the magnetic coil L2′ has one terminal electrically coupled to the high DC voltage VCC as well. The driving circuit 300a includes an IC chip 303 and two switches Q1′ and Q2′. The switches Q1′ and Q2′ both are the NPN bipolar junction transistors (BJT) in the present embodiment. The control terminal, i.e. the base, of the transistor Q1′ is electrically coupled to the chip output terminal DO of the IC chip 3023. The emitter of the transistor Q1′ is electrically coupled to the ground terminal GND. The collector of the transistor Q1′ is electrically coupled to the other terminal of the magnetic coil L1′. The control terminal, i.e. the base, of the transistor Q2′ is electrically coupled to the chip output terminal DOB of the IC chip 303. The emitter of the transistor Q2′ is electrically coupled to the ground terminal GND. The collector of the transistor Q2′ is electrically coupled to the other terminal of the magnetic coil L2′.

Similarly, when the IC chip 302 works, the corresponding currents I_{C1}′ and I_{C2}′ are generated non-simultaneously at the chip output terminals DO and DOB. Besides, the transistors Q1′ and Q2′ are non-simultaneously turned on according to the magnetic field, the controlling state and the currents I_{C1}′ and I_{C2}′, which flow through the chip output terminals DO and DOB respectively, so as to drive the two magnetic coils L1′ and L2′ respectively. The current I_{C1}′ and I_{C2}′ are substantially constant and flow from the chip output terminals DO and DOB. The two magnetic coils L1′ and L2′ are non-simultaneously driven according to respective constant voltages generated by the transistors Q1′ and Q2′.

Furthermore, the driving circuit 300a can also include two resistors R1′ and R2′ and two capacitors C1′ and C2′. The resistor R1′ is electrically coupled between the control terminal of the transistor Q1′ and the chip output terminal DO of the IC chip 303. The resistor R2′ is electrically coupled between the control terminal of the transistor Q2′ and the chip output terminal DOB of the IC chip 303. The two resistors R1′ and R2′ are used to reduce the voltages of the chip output terminals DO and DOB, respectively; that is, to reduce the operating power of the IC chip 303 and further decrease the operating temperature of the IC chip 303. In addition, the two resistors R1′ and R2′, whenever used, have to make the transistors Q1′ and Q2′ operate in the saturation region and make sure that the transistors Q1′ and Q2′ do not over-heat when operated. The two capacitors C1′ and C2′ are electrically coupled to one terminal of the magnetic coil L1′ and one terminal of the magnetic coil L2′, respectively, to further reduce the surge caused by the counter-electromotive force.

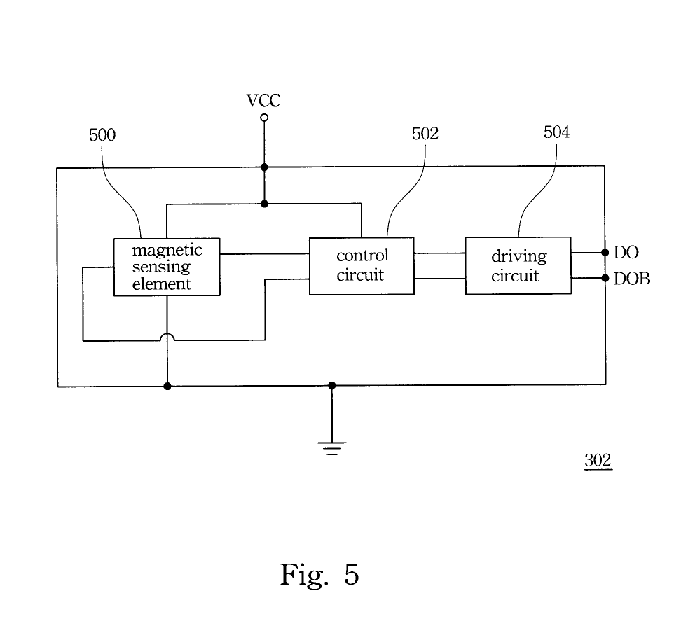

FIG. 5 is a circuit block diagram of the internal part of the IC chip shown in FIG. 3. The IC chip 302 includes a magnetic sensing element 500, a control circuit 502 and a driving circuit 504. The magnetic sensing element 500 detects variations of the magnetic field generated when the DC motor rotates, and outputs a sensing signal accordingly. The control circuit 502 is electrically coupled to the magnetic sensing element 500, and receives the sensing signal output from the magnetic sensing element 500 to output at least one corresponding control signal. The driving circuit 504 is electrically coupled to the control circuit 502, and receives the control signal output from the control circuit 502 to output at least one corresponding driving signal through the chip output terminals DO and DOB.

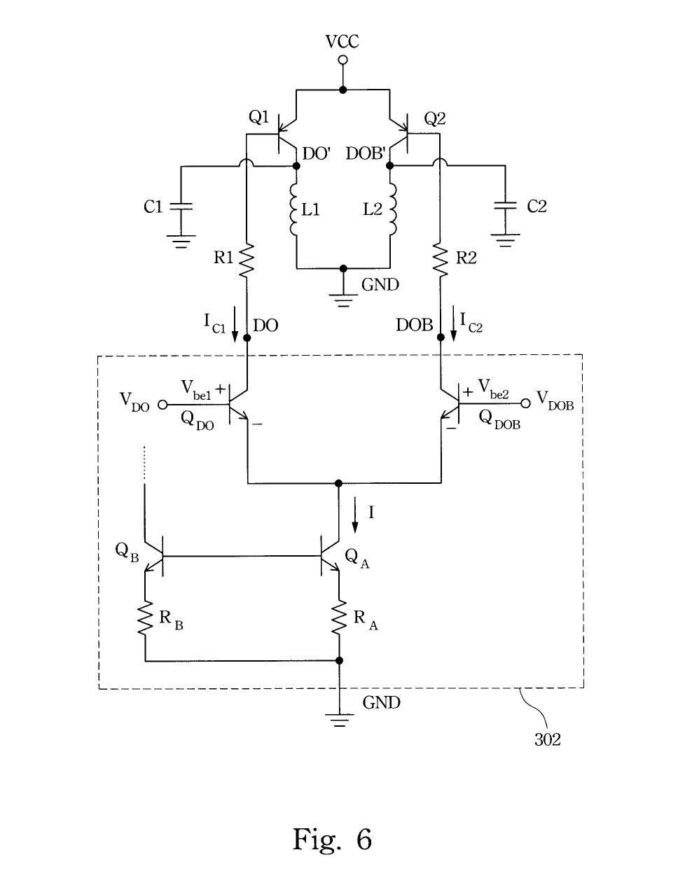

FIG. 6 shows the internal driving circuit of the IC chip shown in FIG. 3 and the external circuit connected thereto. The IC chip 302 includes two switches Q_{DO} and Q_{DOB} and a constant current source for providing a constant current. The switches Q_{DO} and Q_{DOB} are the NPN bipolar junction transistors, and an NPN bipolar junction transistor Q_{A} can carry out the constant current source. The control terminals, i.e. the bases, of the transistors Q_{DO} and Q_{DOB} receive the control voltage signal V_{DO} and V_{DOB}, respectively. The collectors of the transistors Q_{DO} and Q_{DOB} are used as the chip output terminals DO and DOB of the IC chip 302. The control terminal, i.e. the base, of the transistor Q_{A} is biased by another NPN bipolar junction transistor Q_{B}, SO that the transistor Q_{A} is operated in the active region and provides the constant current. The collector of the transistor Q_{A} is electrically coupled to the emitters of the transistors Q_{DO} and Q_{DOB}. The emitter of the transistor Q_{A} is electrically coupled to the ground terminal GND through a resistor R_{A}.

When the transistor Q_{A} is turned on, the transistor Q_{A} is operated in the active region, and the current I flowing through the collector thereof is approximately constant. The two transistors Q_{DO} and Q_{DOB} are controlled with the two control voltage signals V_{DO} and V_{DOB}, and turned on non-simultaneously. When the transistor Q_{DO} is turned on, the transistor Q_{DO} is operated in the active region according to the control voltage signal V_{DO}, and the current I_{C1} flowing through the transistor Q_{DO} is approximately constant. Similarly, When the transistor Q_{DOB} is turned on, the transistor Q_{DOB} is operated in the active region according to the control voltage signal V_{DOB}, and the current I_{C2} flowing through the transistor Q_{DOB} is approximately constant.

When the transistor Q_{DO} is turned on according to the control voltage signal V_{DO}, the transistor Q1 is thus turned on and operated in the saturation region, so that the transistor Q1 amplifies the current I_{C1} flowing through the transistor Q_{DO}, and the corresponding sufficient voltage is generated at the output terminal DO′ to drive the magnetic coil L1. Similarly, when the transistor Q_{DOB} is turned on according to the control voltage signal V_{DOB}, the transistor Q2 is thus turned on and operated in the saturation region, so that the transistor Q2 amplifies the current I_{C2} flowing through the transistor Q_{DOB}, and the corresponding sufficient voltage is generated at the output terminal DOB′ to drive the magnetic coil L2.

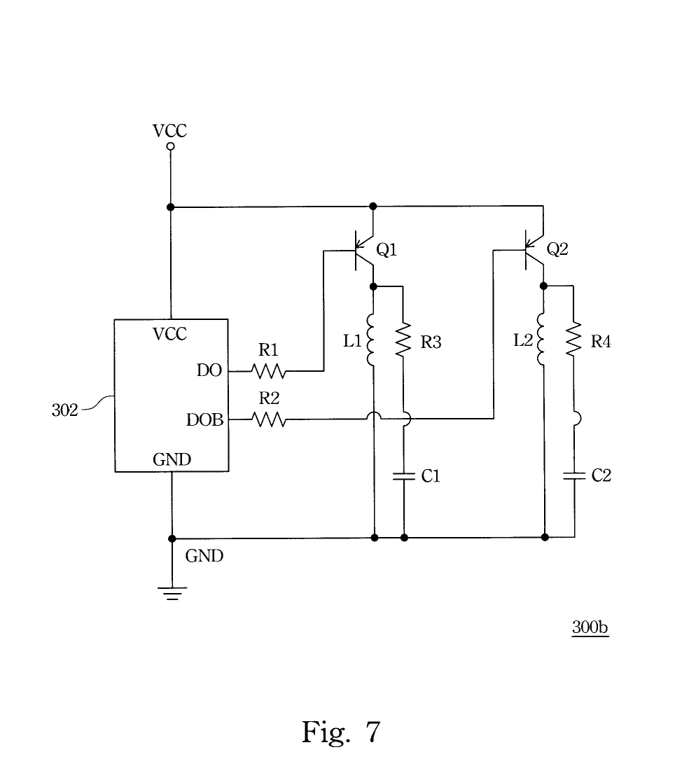

FIG. 7 shows the driving circuit of the DC motor according to a third embodiment of the present invention. Compared to FIG. 3, the driving circuit 300b further includes two resistors R3 and R4. One terminal of the resistor R3 and one terminal of the resistor R4 are electrically coupled to the magnetic coils L1 and L2, respectively, and the collectors of the transistors Q1 and Q2, respectively, and the other terminal of the resistor R3 and the other terminal of the resistor R4 are electrically coupled to the capacitors C1 and C2, respectively, so as to prevent the large instantaneous current from affecting the magnetic coils L1 and L2.

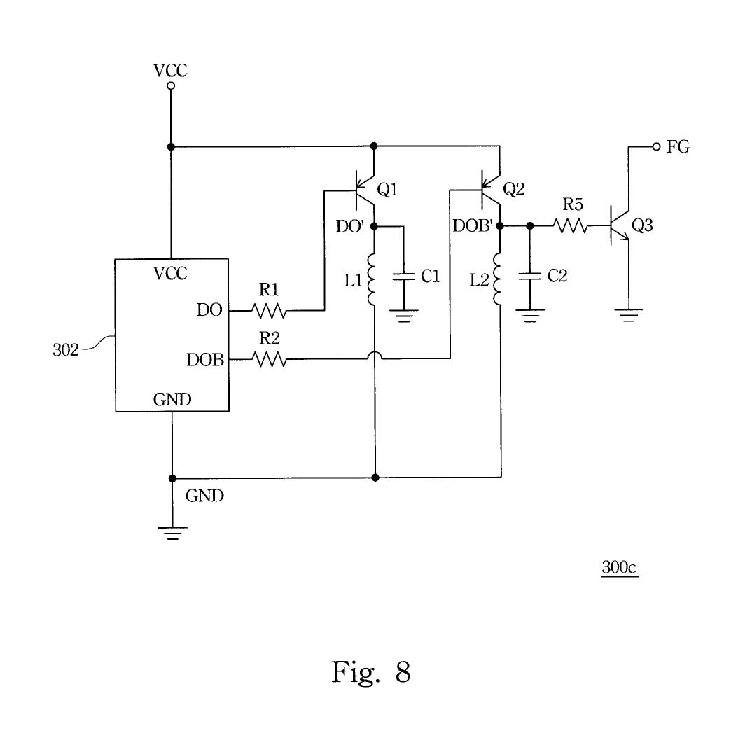

FIG. 8 shows the driving circuit, including the circuit for generating the frequency detection signal, of the DC motor according to a fourth embodiment of the present invention. Compared to FIG. 3, the driving circuit 300c can further include a switch Q3 and a resistor R5, in which the switch Q3 is an NPN bipolar junction transistor in the present embodiment. The control terminal, i.e. the base, of the transistor Q3 is electrically coupled, through the resistor R5, to the collector of the transistor Q2 and the magnetic coil L2. The emitter of the transistor Q3 is electrically coupled to the ground terminal. The collector of the transistor Q3 outputs a voltage detection signal, in which the voltage detection signal is a frequency detection signal FG provided for the control system to detect the rotation speed of the DC motor. In the present embodiment, the transistor Q3 outputs the frequency detection signal FG according to the voltage signal of the output terminal DOB′. In another embodiment, the transistor Q3 outputs the frequency detection signal FG according to the voltage signal of the output terminal DO′.

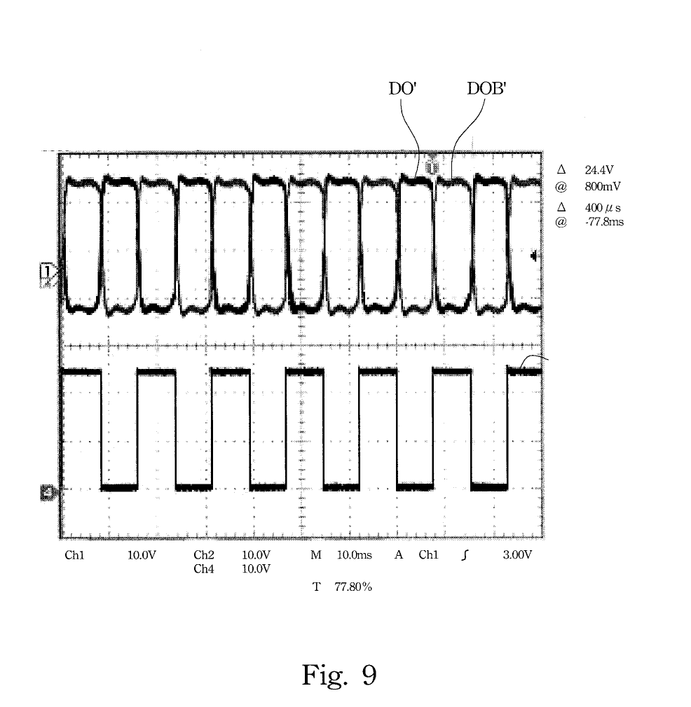

FIG. 9 shows the measured waveforms of the voltages of the output terminals DO′ and DOB′ and the frequency detection signal. Taking the embodiment shown in FIG. 8 for example, when the transistor Q2 turns on or turns off according to the IC chip 302, the transistor Q3 turns on or turns off correspondingly in accordance with the sequentially transformed high-low voltage generated by the transistor Q2, so that the collector of the transistor Q3 can output the corresponding transformed high-low voltage when coupled to a high potential through a load, to generate the frequency detection signal FG.

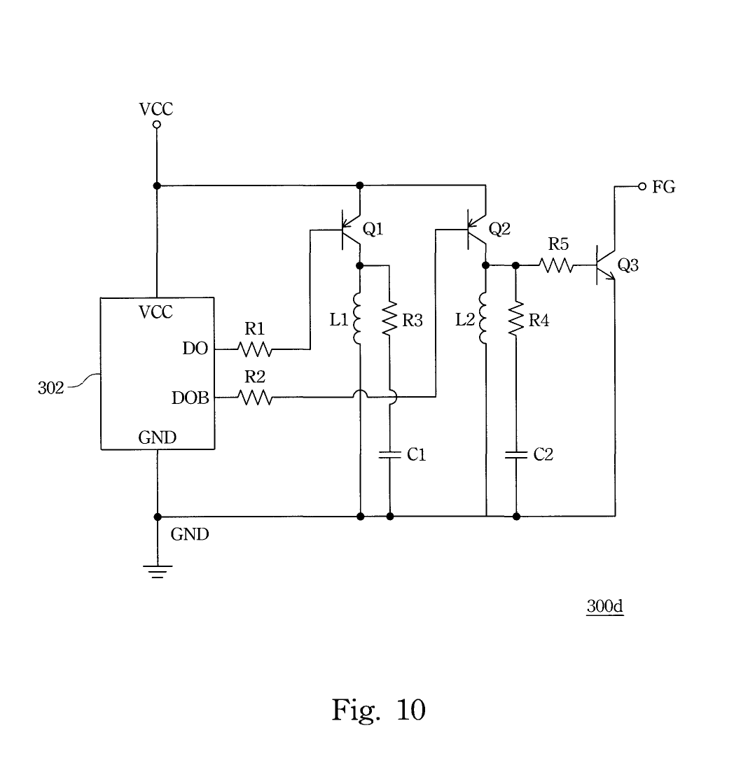

FIG. 10 shows the driving circuit, including the circuit for generating the frequency detection signal, of the DC motor according to a fifth embodiment of the present invention. Compared to FIG. 8, the driving circuit 300d can further include the resistors R3 and R4 as well. One terminal of the resistor R3 and one terminal of the resistor R4 are electrically coupled to the magnetic coils L1 and L2, respectively, and the collectors of the transistors Q1 and Q2, respectively, and the other terminal of the resistor R3 and the other terminal of the resistor R4 are electrically coupled to the capacitors C1 and C2, respectively, so as to prevent the large instantaneous current from affecting the magnetic coils L1 and L2.

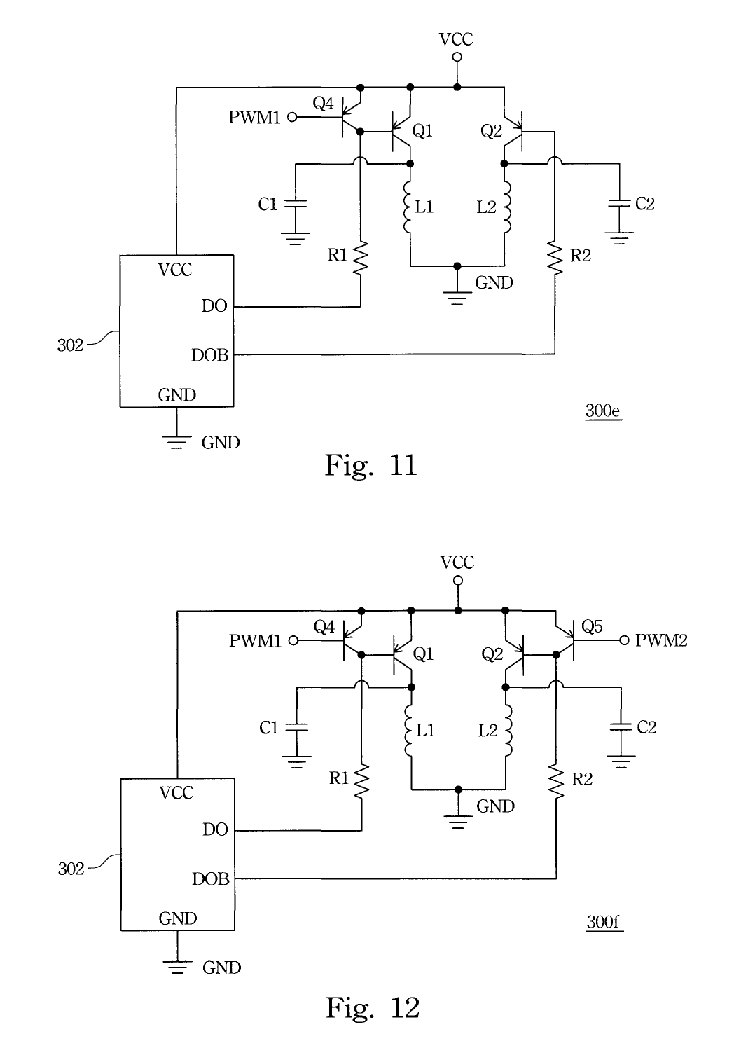

FIG. 11 shows the driving circuit, including the PWM control circuit, of the DC motor according to a sixth embodiment of the present invention. Compared to FIG. 3, the driving circuit 300e further includes a switch Q4, in which the switch Q4 is a PNP bipolar junction transistor in the present embodiment. The control terminal, i.e. the base, of the transistor Q4 receives a pulse width modulation signal PWM1. The emitter of the transistor Q4 is electrically coupled to the high DC voltage VCC. The collector of the transistor Q4 is electrically coupled to the base of the transistor Q1, and electrically coupled to the chip output terminal DO of the IC chip 302 through the resistor R1. When the transistor Q4 is operated in the saturation region, regardless of whether or not a current is generated at the chip output terminal DO, the transistor Q1 is operated in the cut-off region, and the value of the current flowing through the magnetic coil L1 is 0. When the transistor Q4 is operated in the cut-off region, the transistor Q4 can be ignored, so that the transistor Q1 can be operated as usual. Accordingly, regulating the pulse width modulation signal PWM1 can control the transistor Q1, so that the magnetic coil L1 can be switched to move or to stop, to meet the required rotation frequency of the DC motor. In the present embodiment, the transistor Q4 is electrically coupled to the transistor Q1, and electrically coupled to the chip output terminal DO through a resistor. In another embodiment, the transistor Q4 is electrically coupled to the transistor Q2, and electrically coupled to the chip output terminal DOB through a resistor.

FIG. 12 shows the driving circuit, including the PWM control circuit, of the DC motor according to a seventh embodiment of the present invention. Compared to FIG. 11, the driving circuit 300f further includes a switch Q5, in which the switch Q5 is a PNP bipolar junction transistor in the present embodiment. The control terminal, i.e. the base, of the transistor Q5 receives another pulse width modulation signal PWM2. The emitter of the transistor Q5 is electrically coupled to the high DC voltage VCC. The collector of the transistor Q5 is electrically coupled to the base of the transistor Q2, and electrically coupled to the chip output terminal DOB of the IC chip 302 through the resistor R2. Accordingly, regulating the pulse width modulation signals PWM1 and PWM2 can control the transistors Q1 and Q2, so that the magnetic coils L1 and L2 can be switched to move or to stop, to meet the required rotation frequency of the DC motor.

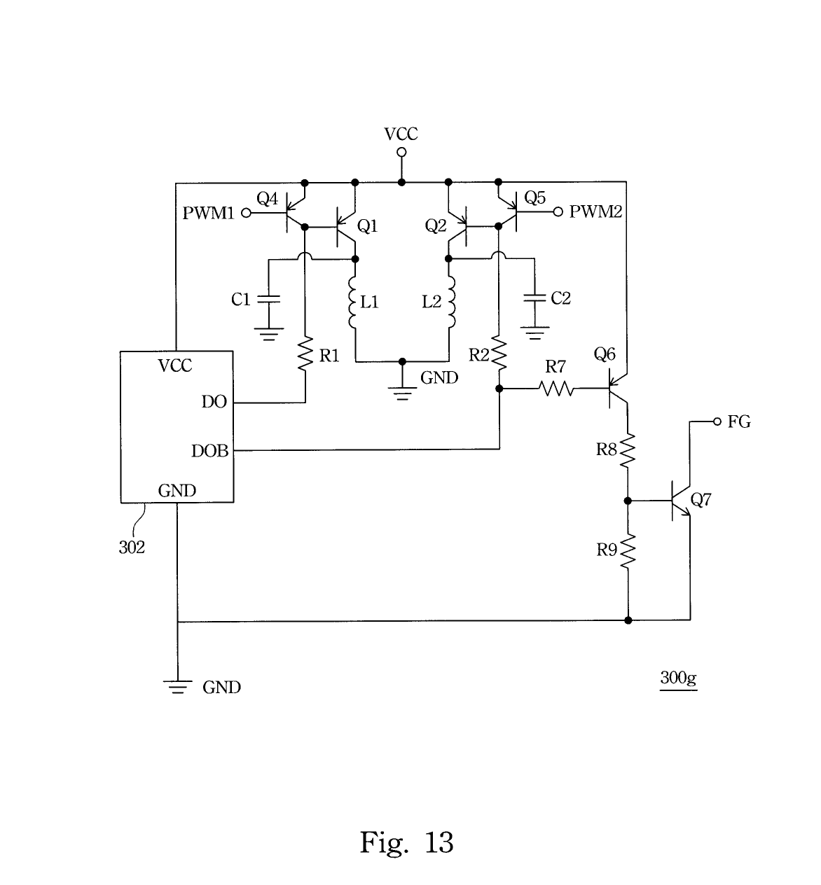

FIG. 13 shows the driving circuit, including the PWM control circuit and the circuit for generating the frequency detection signal, of the DC motor according to an eighth embodiment of the present invention. Compared to FIG. 12, the driving circuit 300g further includes two switches Q6 and Q7, in which the switch Q6 is a PNP bipolar junction transistor and the switch Q7 is a NPN bipolar junction transistor in the present embodiment. The control terminal, i.e. the base, of the transistor Q6 is electrically coupled, through the resistor R7 and R2, to the base of the transistor Q2 and the collector of the transistor Q5, and electrically coupled to the chip output terminal DOB of the IC chip 302. The emitter of the transistor Q6 is electrically coupled to the high DC voltage VCC. The control terminal, i.e. the base, of the transistor Q7 is electrically coupled to the collector of the transistor Q6 through a resistor R8, and electrically coupled to the ground terminal GND through a resistor R9. The emitter of the transistor Q7 is electrically coupled to the ground terminal GND. The collector of the transistor Q7 outputs the frequency detection signal FG for the control system to detect the rotation frequency of the DC motor. Therefore, the pulse width modulation signal can be regulated, and the rotation frequency of the DC motor can be detected at the same time, to obtain the required rotation frequency.

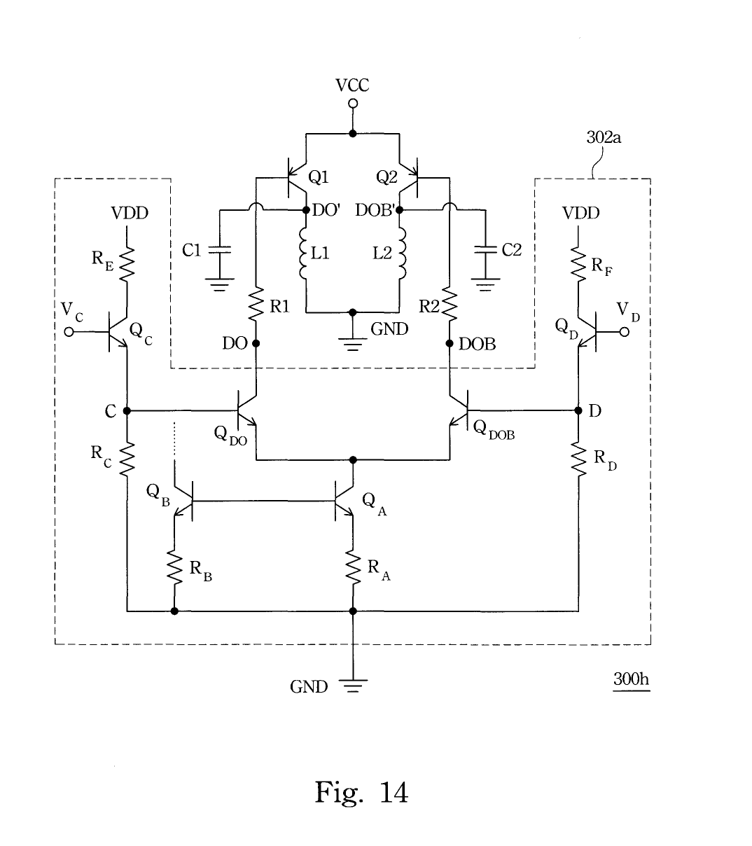

FIG. 14 shows the internal driving circuit of the IC chip and the external circuit connected thereto according to another embodiment of the present invention. Compared to FIG. 6, the IC chip 302a can further include two switches Q_{C} and Q_{D}, in which the switches Q_{C} and Q_{D} both are the NPN bipolar junction transistors in the present embodiment. The base of the transistor Q_{C} receives a control voltage signal V_{C}. The emitter of the transistor Q_{C} is electrically coupled to the base of the transistor Q_{DO}, and electrically coupled to the ground terminal GND through a resistor R_{C}. The collector of the transistor Q_{C} is electrically coupled to a high reference voltage VDD through a resistor R_{E}. The base of the transistor Q_{D} receives a control voltage signal V_{D}. The emitter of the transistor Q_{D} is electrically coupled to the base of the transistor Q_{DOB}, and electrically coupled to the ground terminal GND through a resistor R_{D}. The collector of the transistor Q_{C} is electrically coupled to the high reference voltage VDD through a resistor R_{F}. The transistors Q_{C} and Q_{D} non-simultaneously receive the control voltage signals V_{C} and V_{D}, respectively, to turn on, in which the control voltage signals V_{C} and V_{D} can be generated according to the magnetic sensing element and the control circuit of the IC chip.

When the transistor Q_{C} receives the control voltage signal V_{C} to turn on, the potential of the node C is at a high level, so that the transistor Q_{DO} is turned on and the transistor Q1 is thus turned on to drive the magnetic coil L1. When the transistor Q_{C} receives the control voltage signal V_{C}, which is a low voltage, to turn off, the potential of the node C is at a low level, so that the transistor Q_{DO} is turned off and the transistor Q1 is thus turned off. At the moment, the transistor Q_{D} receives the control voltage signal V_{D} to turn on, and the potential of the node D is at a high level, so that the transistor Q_{DOB} is turned on and the transistor Q2 is thus turned on to drive the magnetic coil L2. Therefore, the control voltage signals V_{C} and V_{D} drive the magnetic coils L1 and L2.

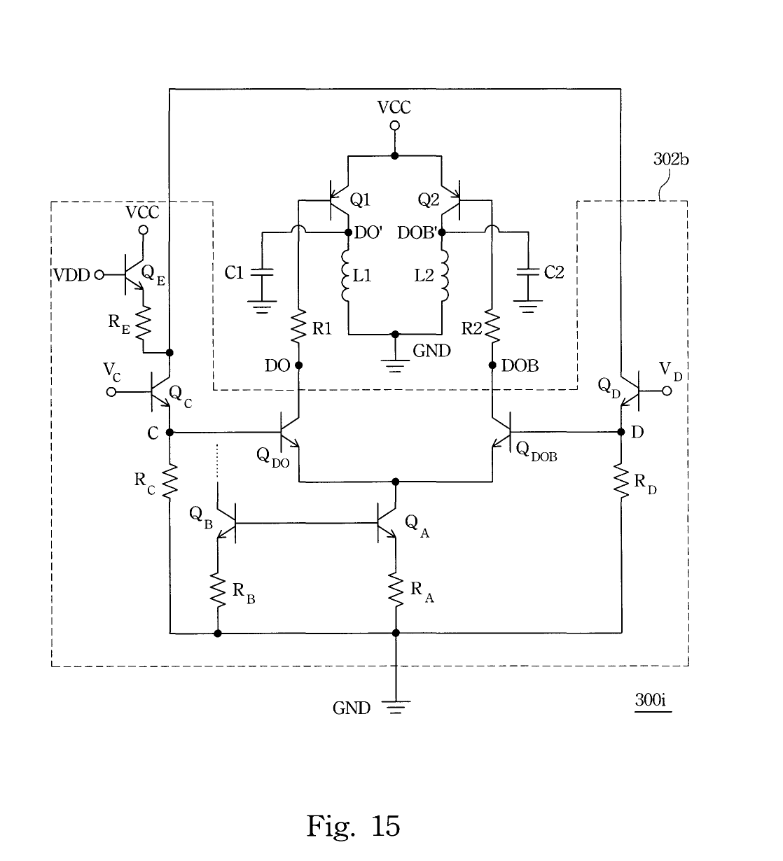

FIG. 15 shows the internal driving circuit of the IC chip and the external circuit connected thereto according to yet another embodiment of the present invention. Compared to FIG. 14, the IC chip 302b can further include two switches Q_{E}, in which the switches Q_{E} is a NPN bipolar junction transistor in the present embodiment. The control terminal, i.e. the base, is electrically coupled to the high reference voltage VDD. The collector of the transistor Q_{E} is electrically coupled to the high DC voltage VCC. The emitter of the transistor Q_{E} is electrically coupled to the collectors of the transistors Q_{C} and Q_{D}. In the present embodiment, when the transistors Q_{C} and Q_{D} are switched repeatedly according to the control voltage signals V_{C} and V_{D}, the high reference voltage VDD, the transistor Q_{E} and the resistor R_{E} are capable of stabilizing the currents flowing through the transistors Q_{C} and Q_{D}.

Practicing Principles and Results

The transistor, which is used to drive the magnetic coil, is repeatedly turned on and turned off according to the control signal, so the current flowing through the magnetic coil is varied on a wide range instantaneously, such that the change of the magnetic field generated by the magnetic coil induces a counter-electromotive force, and the counter-electromotive force make the magnetic coil and the whole motor produce the noise continually. The change of the counter-electromotive force can be obtained as follows:

dV=L*di/dt

in which dV is the voltage change induced by the change of the current flowing through the magnetic coil, L is the inductance of the magnetic coil, and di/dt is the instantaneous change rate of the current, flowing through the magnetic coil, relative to the time. Therefore, the voltage change can be reduced if the instantaneous change of the current flowing through the magnetic coil can be reduced, to further reduce the noise produced by the motor.

The driving circuit according to the embodiment of the present invention is analyzed as follows. Referring to FIG. 6, for the transistors Q_{DO} and Q_{DOB}, the currents I_{C1} and I_{C2} generated by the collectors of the transistors Q_{DO} and Q_{DOB}, respectively, can be expressed as follows:

I_{C1}=I_{S}*exp(V_{be1}/V_{T})

I_{C2}=I_{S}*exp(V_{be2}/V_{T})

in which I_{S} is a current amplified constant, V_{T} is the thermal voltage varied with the temperature change. Furthermore, I_{C1}+I_{C2}=I, and V_{be1}−V_{be2}=V_{DO}−V_{DOB}=V_{id}, in which I is the constant current flowing through the collector of the transistor Q_{A}. So, the equation (1) and the equation (2) can be obtained after the derivation:

I_{C1}=I/(1+exp(−V_{id}/V_{T})) (1)

i I_{C2}=I/(1+exp(V_{id}/V_{T})) (2)

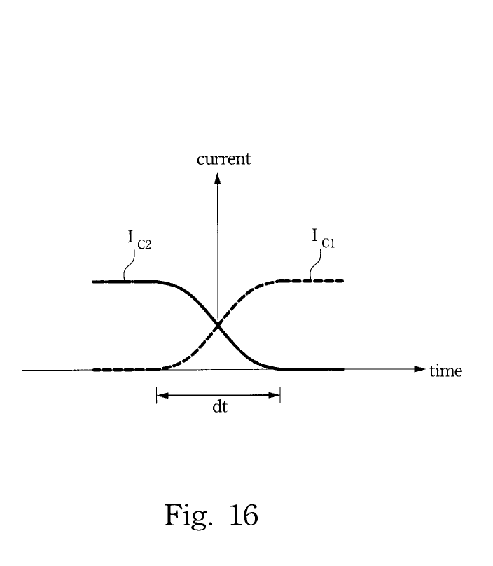

FIG. 16 shows the partial waveforms of the currents, which are of the collectors of the transistors Q_{DO} and Q_{DOB}, relative to the time. Referring to FIG. 16 and the equations (1) and (2), when the transistors Q_{DO} and Q_{DOB} are switched; that is, during the change time dt, the values of the currents I_{C1} and I_{C2} vary according to the voltage V_{id}, and have a approximately linear variation. Therefore, the instantaneous change rate of the current, flowing through the magnetic coil, relative to the time, i.e. di/dt, is approximately constant. In other words, the voltage across the magnetic coil does not vary instantaneously on a wide range, and the noise generated by the motor can relatively be reduced. Moreover, the transistors Q1 and Q2 use the constant-voltage driving method to amplify the currents flowing through the collectors of the transistors Q_{DO} and Q_{DOB}, such that the driving circuit is suitable for the fast-rotation and large-current motors.

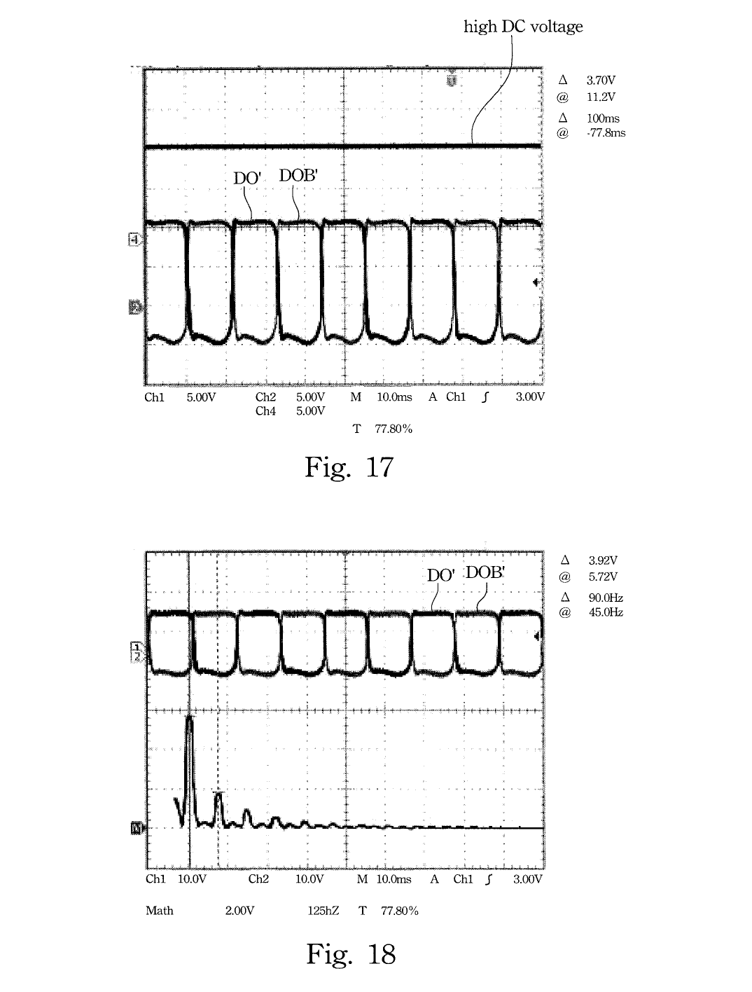

FIG. 17 shows the measured waveforms of the output voltages of the output terminals DO′ and DOB′ and the DC power supply shown in FIG. 6 when the high DC voltage is 12V. The results in FIG. 17 clearly show that the noise no longer interferes with the DC power supply; that is, the noise problem, which is caused by the motor, has already been solved. FIG. 18 shows the measured waveforms and the corresponding spectrum of the output voltages of the output terminals DO′ and DOB′ shown in FIG. 6 when the high DC voltage is 12V. The results in FIG. 18 clearly show that the proportion of the even-fold frequencies has already decreased, and the odd-fold frequencies can be almost ignored after a certain frequency, such as the ninefold frequency, and the convergence improves as well.

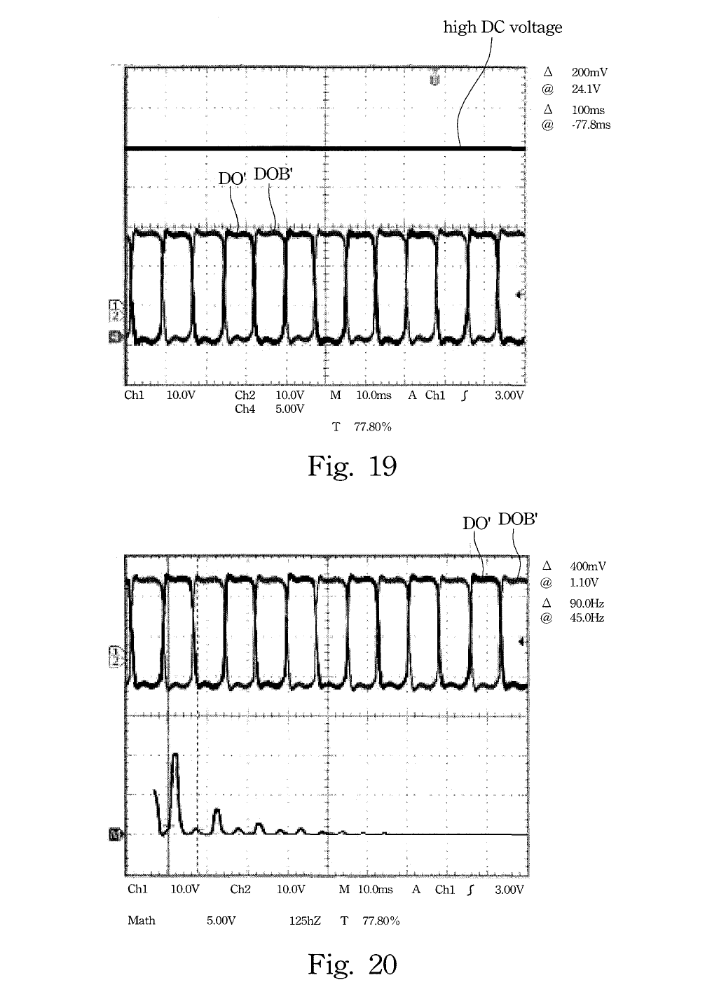

FIG. 19 shows the measured waveforms of the output voltages of the output terminals DO′ and DOB′ and the DC power supply shown in FIG. 6 when the high DC voltage is 24V. The results in FIG. 19 clearly show that, when the DC voltage is increased, the waveforms of output voltages of the output terminals DO′ and DOB′ are still quite stable, and the noise no longer interferes with the DC power supply. This reveals that the applied DC voltage does not have a significant effect on the driving circuit. FIG. 20 shows the measured waveforms and the corresponding spectrum of the output voltages of the output terminals DO′ and DOB′ shown in FIG. 6 when the high DC voltage is 24V. The results in FIG. 20 clearly show that the convergence also improves.

For the foregoing embodiments of the present invention, the driving circuit of the DC motor has the advantages of using the constant-current and constant-voltage driving method for reducing the noise caused by the motor, and is suitable for a fast-rotation and large-current motor.

As is understood by a person skilled in the art, the foregoing preferred embodiments of the present invention are illustrative of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A constant-current and constant-voltage driving circuit of a direct-current motor, the direct-current motor comprising a first magnetic coil and a second magnetic coil, wherein the first magnetic coil has a first terminal and a second terminal, the second magnetic coil has a third terminal and a fourth terminal, and the second terminal and the fourth terminal are electrically coupled to a first reference voltage, the constant-current and constant-voltage driving circuit comprising:
an integrated circuit chip having a first chip output terminal and a second chip output terminal;
a first switch having a first control terminal, a fifth terminal and a sixth terminal, wherein the first control terminal is electrically coupled to the first chip output terminal of the integrated circuit chip, the fifth terminal is electrically coupled to a second reference voltage, and the sixth terminal is electrically coupled to the first terminal of the first magnetic coil; and
a second switch having a second control terminal, a seventh terminal and an eighth terminal, wherein the second control terminal is electrically coupled to the second chip output terminal of the integrated circuit chip, the seventh terminal is electrically coupled to the second reference voltage, and the eighth terminal is electrically coupled to the third terminal of the second magnetic coil;
wherein the first switch and the second switch are non-simultaneously turned on according to a first current and a second current respectively flowing through the first chip output terminal and the second chip output terminal, so as to drive the first magnetic coil and the second magnetic coil respectively, wherein the first current or the second current is substantially constant, and the first magnetic coil and the second magnetic coil are non-simultaneously driven according to respective constant voltages generated by the first switch and the second switch.

2. The constant-current and constant-voltage driving circuit as claimed in claim 1, wherein the first switch is a first PNP bipolar junction transistor, the second switch is a second PNP bipolar junction transistor, the first PNP bipolar junction transistor and the second PNP bipolar junction transistor are non-simultaneously turned on to be operated in a saturation region according to the integrated circuit chip and amplify the first current and the second current respectively, the first control terminal, the fifth terminal and the sixth terminal are respectively a base, an emitter and a collector of the first PNP bipolar junction transistor, and the second control terminal, the seventh terminal and the eighth terminal are respectively a base, an emitter and a collector of the second PNP bipolar junction transistor.

3. The constant-current and constant-voltage driving circuit as claimed in claim 1, wherein the first switch is a first NPN bipolar junction transistor, the second switch is a second NPN bipolar junction transistor, the first NPN bipolar junction transistor and the second NPN bipolar junction transistor are non-simultaneously turned on to be operated in a saturation region according to the integrated circuit chip and amplify the first current and the second current respectively, the first control terminal, the fifth terminal and the sixth terminal are respectively a base, an emitter and a collector of the first NPN bipolar junction transistor, and the second control terminal, the seventh terminal and the eighth terminal are respectively a base, an emitter and a collector of the second NPN bipolar junction transistor.

4. The constant-current and constant-voltage driving circuit as claimed in claim 1, further comprising:
a first resistor electrically coupled between the first chip output terminal of the integrated circuit chip and the first control terminal of the first switch; and
a second resistor electrically coupled between the second chip output terminal of the integrated circuit chip and the second control terminal of the second switch.

5. The constant-current and constant-voltage driving circuit as claimed in claim 1, further comprising:
a first capacitor electrically coupled to the sixth terminal of the first switch; and
a second capacitor electrically coupled to the eighth terminal of the second switch.

6. The constant-current and constant-voltage driving circuit as claimed in claim 5, further comprising:
a third resistor electrically coupled between the sixth terminal of the first switch and the first capacitor; and
a fourth resistor electrically coupled between the eighth terminal of the second switch and the second capacitor.

7. The constant-current and constant-voltage driving circuit as claimed in claim 1, further comprising:
a third NPN bipolar junction transistor having a third control terminal, a ninth terminal and a tenth terminal, wherein the third control terminal is electrically coupled to the eighth terminal of the second switch and the third terminal of the second magnetic coil, the ninth terminal is used for outputting a voltage detection signal, the tenth terminal is electrically coupled to the first reference voltage, and the third control terminal, the ninth terminal and the tenth terminal are respectively a base, a collector and an emitter of the third NPN bipolar junction transistor; and
a fifth resistor electrically coupled between the third control terminal of the third NPN bipolar junction transistor and the eighth terminal of the second switch.

8. The constant-current and constant-voltage driving circuit as claimed in claim 7, wherein the voltage detection signal is a frequency detection signal.

9. The constant-current and constant-voltage driving circuit as claimed in claim 7, further comprising:
a sixth resistor electrically coupled between the sixth terminal of the first switch and the first capacitor; and
a fourth resistor electrically coupled between the eighth terminal of the second switch and the second capacitor.

10. The constant-current and constant-voltage driving circuit as claimed in claim 1, further comprising:
a fourth PNP bipolar junction transistor having a fourth control terminal, a eleventh terminal and a twelfth terminal, wherein the fourth control terminal is used for receiving a pulse width modulation signal, the eleventh terminal is electrically coupled to the second reference voltage, the twelfth terminal is electrically coupled to the first control terminal of the first switch, and the fourth control terminal, the eleventh terminal and the twelfth terminal are respectively a base, an emitter and a collector of the fourth PNP bipolar junction transistor.

11. The constant-current and constant-voltage driving circuit as claimed in claim 1, further comprising:
a fifth PNP bipolar junction transistor having a fifth control terminal, a thirteenth terminal and a fourteenth terminal, wherein the fifth control terminal is used for receiving a first pulse width modulation signal, the thirteenth terminal is electrically coupled to the second reference voltage, the fourteenth terminal is electrically coupled to the first control terminal of the first switch and the first chip output terminal of the integrated circuit chip; and
a sixth PNP bipolar junction transistor having a sixth control terminal, a fifteenth terminal and a sixteenth terminal, wherein the sixth control terminal is used for receiving a second pulse width modulation signal, the fifteenth terminal is electrically coupled to the second reference voltage, the sixteenth terminal is electrically coupled to the second control terminal of the second switch and the second chip output terminal of the integrated circuit chip;
wherein the fifth control terminal, the thirteenth terminal and the fourteenth terminal are respectively a base, an emitter and a collector of the fifth PNP bipolar junction transistor, and the sixth control terminal, the fifteenth terminal and the sixteenth terminal are respectively a base, an emitter and a collector of the sixth PNP bipolar junction transistor.

12. The constant-current and constant-voltage driving circuit as claimed in claim 11, further comprising:
a seventh PNP bipolar junction transistor having a seventh control terminal, a seventeenth terminal and a eighteenth terminal, wherein the seventh control terminal is electrically coupled to the second control terminal of the second switch, the sixteenth terminal of the sixth PNP bipolar junction transistor and the second chip output terminal of the integrated circuit chip, and the seventeenth terminal is electrically coupled to second reference voltage;
an eighth NPN bipolar junction transistor having an eighth control terminal, a nineteenth terminal and a twentieth terminal, wherein the eighth control terminal is electrically coupled to the eighteenth terminal of the seventh PNP bipolar junction transistor, the nineteenth terminal is used for outputting a voltage detection signal, and the twentieth terminal is electrically coupled to the first reference voltage;
an eighth resistor electrically coupled between the seventh control terminal of the seventh PNP bipolar junction transistor and the second chip output terminal of the integrated circuit chip; and
a ninth resistor electrically coupled between the eighteenth terminal of the seventh PNP bipolar junction transistor and the eighth control terminal of the eighth NPN bipolar junction transistor;
wherein the seventh control terminal, the seventeenth terminal and the eighteenth terminal are respectively a base, an emitter and a collector of the seventh PNP bipolar junction transistor, and the eighth control terminal, the nineteenth terminal and the twentieth terminal are respectively a base, a collector and an emitter of the eighth NPN bipolar junction transistor.

13. The constant-current and constant-voltage driving circuit as claimed in claim 12, wherein the voltage detection signal is a frequency detection signal.

14. The constant-current and constant-voltage driving circuit as claimed in claim 1, wherein the integrated circuit chip further comprises:
a magnetic sensing element for detecting variations of a magnetic field generated when the direct-current motor rotating and for outputting a sensing signal;
a control circuit electrically coupled to the magnetic sensing element and receiving the sensing signal to output at least one corresponding control signal; and
a driving circuit electrically coupled to the control circuit and receiving the control signal to output at least one corresponding driving signal.

15. The constant-current and constant-voltage driving circuit as claimed in claim 1, wherein the integrated circuit chip further comprises:
a ninth switch having an ninth control terminal, a twenty-first terminal and a twenty-second terminal, wherein the twenty-first terminal is the first chip output terminal;
a tenth switch having an tenth control terminal, a twenty-third terminal and a twenty-fourth terminal, wherein the twenty-third terminal is the second chip output terminal; and
a constant current source providing a constant current and having a twenty-fifth terminal and a twenty-sixth terminal, wherein the twenty-fifth terminal is electrically coupled to the twenty-second terminal of the ninth switch and the twenty-fourth terminal of the tenth switch, and the twenty-sixth terminal is electrically coupled to the first reference voltage.

16. The constant-current and constant-voltage driving circuit as claimed in claim 15, wherein the ninth switch is a ninth NPN bipolar junction transistor, the ninth control terminal is used for receiving a first control voltage signal so that the ninth NPN bipolar junction transistor is operated in an active region or a cut-off region, the tenth switch is a tenth NPN bipolar junction transistor, the tenth control terminal is used for receiving a second control voltage signal so that the tenth NPN bipolar junction transistor is operated in the active region or the cut-off region, the ninth control terminal, the twenty-first terminal and the twenty-second terminal are respectively a base, a collector and an emitter of the ninth NPN bipolar junction transistor, and the tenth control terminal, the twenty-third terminal and the twenty-fourth terminal are respectively a base, a collector and an emitter of the tenth NPN bipolar junction transistor.

17. The constant-current and constant-voltage driving circuit as claimed in claim 15, wherein the constant current source comprises:
an eleventh NPN bipolar junction transistor having an eleventh control terminal, wherein the eleventh control terminal is used for receiving a bias so that the eleventh NPN bipolar junction transistor is operated in an active region and provides the constant current, and the eleventh control terminal, the twenty-fifth terminal and the twenty-sixth terminal are respectively a base, a collector and an emitter of the eleventh NPN bipolar junction transistor.

18. The constant-current and constant-voltage driving circuit as claimed in claim 15, wherein the integrated circuit chip further comprises:
a twelfth NPN bipolar junction transistor having a twelfth control terminal, a twenty-seventh terminal and a twenty-eighth terminal, wherein the twelfth control terminal is used for receiving a third control voltage signal, and the twenty-eighth terminal is electrically coupled to the first reference voltage and the ninth control terminal of the ninth switch; and
a thirteenth NPN bipolar junction transistor having a thirteenth control terminal, a twenty-ninth terminal and a thirtieth terminal, wherein the thirteenth control terminal is used for receiving a fourth control voltage signal, and the thirtieth terminal is electrically coupled to the first reference voltage and the tenth control terminal of the tenth switch;
wherein the twelfth control terminal, the twenty-seventh terminal and the twenty-eighth terminal are respectively a base, a collector and an emitter of the twelfth NPN bipolar junction transistor, and the thirteenth control terminal, a twenty-ninth terminal and a thirtieth terminal are respectively a base, a collector and an emitter of the thirteenth NPN bipolar junction transistor.

19. The constant-current and constant-voltage driving circuit as claimed in claim 18, wherein the collectors of the twelfth NPN bipolar junction transistor and the thirteenth NPN bipolar junction transistor are coupled to a third reference voltage respectively through resistors.

20. The constant-current and constant-voltage driving circuit as claimed in claim 18, further comprising:
a fourteenth NPN bipolar junction transistor having a fourteenth control terminal, a thirty-first terminal and a thirty-second terminal, wherein the fourteenth control terminal is electrically coupled to a third reference voltage, the thirty-first terminal is electrically coupled to the second reference voltage, the thirty-second terminal is electrically coupled to the collectors of the twelfth NPN bipolar junction transistor and the thirteenth NPN bipolar junction transistor, and the fourteenth control terminal, the thirty-first terminal and the thirty-second terminal are respectively a base, a collector and an emitter of the fourteenth NPN bipolar junction transistor.

21. The constant-current and constant-voltage driving circuit as claimed in claim 1, wherein the integrated circuit chip is made in a single-in-line package form with four pins, and the pins comprises the first chip output terminal, the second chip output terminal, a third chip output terminal for being electrically coupled to the second reference voltage, and a fourth chip output terminal for being electrically coupled to the first reference voltage.

22. The constant-current and constant-voltage driving circuit as claimed in claim 1, wherein the constant-current and constant-voltage driving circuit is used for driving a direct-current brushless fan motor.
